(19) United States
(12) Patent Application Publication
(10) Pub. No.: US 2008/0048945 A1
(43) Pub. Date: Feb. 28, 2008

(54) ELECTRO-OPTICAL DEVICE, METHOD OF DRIVING THE SAME, AND ELECTRONIC APPARATUS

(75) Inventors: Hiroaki JO, Suwa-shi (JP); Shinsuke FUJIKAWA, Chino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/617,525

(22) Filed: Dec. 28, 2006

(30) Foreign Application Priority Data
Jan. 6, 2006 (JP) 2006-001112

(51) Int. Cl. G09G 3/30

(52) U.S. Cl. 345/76

(57) ABSTRACT

An electro-optical device includes a plurality of unit circuits that are arranged therein. Each of the plurality of unit circuits includes an electro-optical element that has a gray-scale level according to a current value of a driving current, a reference setting unit that generates a reference signal having a level according to correction data of the unit circuit, and a current control unit that controls the driving current to be supplied to the electro-optical element to a current value according to gray-scale data assigning a gray-scale level of the unit circuit and the level of the reference signal generated by the reference setting unit.

This application claims priority from Japanese Patent Application No. 2006-001112, filed in the Japanese Patent Office on Jan. 6, 2006, the entire disclosure of which is hereby incorporated by reference in its entirety.

### BACKGROUND

1. Technical Field

The present invention relates to a technology for controlling an electro-optical element, such as an organic light-emitting diode (hereinafter, referred to as ‘OLED’) element or the like.

2. Related Art

An electro-optical device in which a plurality of electro-optical elements are arranged has been suggested. In such an electro-optical device, irregularity in gray-scale level over the plurality of electro-optical elements may occur due to a variation in a characteristic (for example, light-emission efficiency) of the individual electro-optical elements or a variation in a characteristic (for example, threshold voltage) of transistors controlling the electro-optical elements. In order to control such an irregularity in gray-scale level (luminance), for example, JP-A-2005-283816 discloses a technology that corrects gray-scale data of the individual electro-optical elements (data for assigning luminance). In this technology, gray-scale data of each of the electro-optical elements is corrected on the basis of a luminance ratio of the electro-optical elements measured in advance, and the electro-optical elements are driven on the basis of the gray-scale data after correction.

However, in the configuration disclosed in JP-A-2005-283816, a circuit that corrects the gray-scale data on the basis of the luminance ratio of the individual electro-optical elements is required. Accordingly, there is a problem in that the size of a circuit (hereinafter, referred to as ‘peripheral circuit’) to be disposed in the vicinity of the electro-optical element is made large.

### SUMMARY

An advantage of some aspects of the invention is that it provides an electro-optical device that can suppress irregularity in gray-scale level of individual electro-optical elements while suppressing the size of a peripheral circuit.

According to an aspect of the invention, an electro-optical device includes a plurality of unit circuits. Each of the unit circuits includes an electro-optical element that has a gray-scale level according to a current value of a driving current, a reference setting unit (for example, a reference setting circuit U of FIG. 2) that generates a reference signal having a level according to correction data of the unit circuit, a current control unit (for example, a driving transistor Tdr of FIG. 2) that controls the driving current to be supplied to the electro-optical element to a current value according to gray-scale data assigning a gray-scale level of the unit circuit and the level of the reference signal generated by the reference setting unit.

With this configuration, the driving current that determines the gray-scale level of the electro-optical element of each unit circuit is controlled to the current value in which the correction data of the unit circuit is reflected. Accordingly, irregularity in gray-scale level of each electro-optical element can be suppressed according to the correction data. Besides, since the reference setting unit that generates the reference signal according to the correction data is provided in each unit circuit, a peripheral circuit that corrects gray-scale data on the basis of the correction data is not required in principle. Therefore, the size of the peripheral circuit can be reduced.

Moreover, although the circuit that corrects the gray-scale data on the basis of the correction data is not required in principle, an electro-optical device in which the reference setting unit of each unit circuit corrects the gray-scale level of each electro-optical element and the peripheral circuit corrects the gray-scale data still falls within the scope of the invention. In an electro-optical device that performs various kinds of correction, at least one kind of correction may be performed by the reference setting unit of each unit circuit. In this case, since the peripheral circuit does not need to perform that correction, the size of the peripheral circuit can be reduced compared with a known configuration where all kinds of correction are performed by the peripheral circuit. For example, a variation in a characteristic of the electro-optical elements may be compensated through the correction performed by the reference setting unit of each unit circuit, and the peripheral circuit may perform gamma correction on the gray-scale data.

According to the aspect of the invention, the electro-optical element is an element (so-called current-driven type) in which an optical characteristic, such as luminance or transmittance changes by supply of a current. An example of such an electro-optical element includes a light-emitting element (for example, an OLED element) that emits light with luminance according to the current value of the driving current. Alternatively, the invention can be applied to an electro-optical device that uses other electro-optical elements.

In the electro-optical device according to the aspect of the invention, the reference setting unit may generate a reference current having a current value according to the correction data as the reference signal. In this case, an example of the reference setting unit includes a current output-type DAC (Digital to Analog Converter). With this configuration, the driving current is generated by changing the current value of the reference current generated by the reference setting unit, and thus the configuration of each unit circuit can be simplified compared with a case where the reference signal having the current value according to the correction data is generated. However, the invention can be applied to a case where the reference setting unit generates the reference signal having the current value according to the correction data (the reference setting unit is a voltage output-type DAC). With this configuration, for example, the electro-optical element is interposed between a wiring line to which the reference setting unit outputs the reference signal and a power line (for example, a ground line), and the current control unit controls a current flowing between the wiring line and the power line according to the gray-scale data, thereby generating the driving current.

In the electro-optical device according to the aspect of the invention, in which the reference setting unit generates the reference current, the current control unit may include a driving transistor that is disposed on a second path branching off a first path from the reference setting unit to the electro-optical element so as to control a current of the second path according to the gray-scale data. With this configuration, the current value of the driving current (further, a gray-scale level of the electro-optical element) is controlled according to the current of the second path. That is, a ratio between a current flowing in the driving transistor and the driving current to be supplied to the electro-optical element is controlled by according to the gray-scale data. With this configuration, since the reference current generated by the reference setting unit (the sum of the current flowing in the driving transistor and the driving current to be supplied to the electro-optical element) does not change, a change in potential of the power line as a source of the reference current is suppressed.

In the electro-optical device according to the aspect of the invention, a resistive element (for example, a resistive element Rb of FIGS. 9 to 11) is disposed on a path of a current passing through the reference setting unit and the driving transistor. With this configuration, since it is possible to approximate a resistance value of the first path and a resistance value of the second path to each other, power consumption can be made uniform when the driving current is supplied to the first path (for example, when the electro-optical element is turned on) and when a current is supplied to the second path (for example, when the electro-optical element is turned off). Therefore, the change in potential of the power line is further effectively suppressed.

In the invention, the current control unit is not limited to the above illustration. For example, another current control unit may include a driving transistor that is disposed on a path from the reference setting unit to the electro-optical element. That is, in this case, the driving transistor has a first terminal (one of a drain and a source) electrically connected to the reference setting unit and a second terminal (the other of the drain and the source) electrically connected to the electro-optical element. A potential according to the gray-scale data is supplied to a gate electrode thereof. With this configuration, the driving current to be supplied from the reference setting unit to the electro-optical element can be controlled according to the gray-scale data.

In the electro-optical device according to the aspect of the invention, the reference setting unit of each of the unit circuits may include a plurality of current sources (for example, current source transistors Ts1 to Ts3 of FIG. 2) that respectively generate a current according to the correction data of the unit circuit, and may generate the reference current by adding the currents generated by the individual current sources. With this configuration, the reference current can be generated by a simple configuration for adding the currents from the individual current sources (for example, the configuration in which output terminals of the individual current sources are connected to one another).

The electro-optical device according to the aspect of the invention may further include a potential generation unit that generates a first potential (for example, a first potential V1 of FIG. 1) and a second potential (for example, a second potential V2 of FIG. 1). Each of the current sources may include a first transistor (for example, one of current source transistors Ts1 to Ts3 of FIG. 2) that generates a current according to a potential of its gate electrode. One of the first potential and the second potential generated by the potential generation unit may be supplied to the gate electrode of the first transistor according to the correction data. With this configuration, since the first transistor is controlled by either the first potential or the second potential in a two-value manner, an influence of a variation in a characteristic (for example, a threshold voltage) of the first transistor in each of the unit circuits on the gray-scale level of the electro-optical element (irregularity in gray-scale level due to the variation in the characteristic of the first transistor) can be reduced. In the electro-optical device according to the aspect of the invention, the first potential may be a potential that operates the first transistor in a saturation region, and the second potential may be a potential that turns off the first transistor. With this configuration, the influence of the variation in the characteristic of the first transistor on the gray-scale level of the electro-optical element can be effectively suppressed.

As described above, when the first potential or the second potential is supplied to the gate electrode of the first transistor, the potential generation unit may variably generate the first potential. With this configuration, the gray-scale levels (luminance) of the plurality of electro-optical elements can be collectively adjusted by suitably changing the first potential generated by the potential generation unit. For example, when the electro-optical device according to the aspect of the invention is used to output (display or print) an image, brightness of the output image can be adjusted according to the first potential. Moreover, in this case, the second potential may be varied or fixed.

The configuration for varying the first potential is arbitrarily set. For example, a circuit including a unit (for example, a resistive voltage dividing circuit 251 of FIG. 3) for generating a plurality of potentials by dividing a predetermined voltage and a unit (for example, a selector 253 of FIG. 3) for selecting one of the potentials as the first potential is adopted as the potential generation unit. Further, the first potential may be varied by suitably changing a division ratio of the predetermined voltage, for example, by a variable resistive element (for example, a variable resistive element Rx of FIG. 13).

In the electro-optical device according to the aspect of the invention, each of the unit circuits may include a current generation circuit (for example, a transistor Tc of FIG. 5) that generates a current having a current value not depending on the correction data, and the reference setting unit may generate the reference current by adding the current generated by each current source and the current generated by the current generation circuit. With this configuration, since the reference current is generated by adding the currents generated by the individual current sources and the current generated by the current generation circuit, the current value of the reference current can be set with high precision at minute steps while reducing the number of bits of the correction data, compared with a case where the reference current is generated by adding only the currents generated by the individual current sources.

The electro-optical device according to the aspect of the invention may further include a first potential generation unit (for example, a potential generation circuit 25 of FIG. 1) that generates a first potential and a second potential different from each other, and a second potential generation unit (for example, a potential generation circuit 25 of FIG. 1) that generates an on-potential (for example, a potential Von of FIG. 5) not depending on the first potential and the second potential. Each of the plurality of current sources may include a first transistor (for example, one of current source transistor Ts1 to Ts3 of FIG. 5) that generates a current according to a potential of its gate electrode. The current generation circuit may include a second transistor (for example, a transistor Tc of FIG. 5) that generates a current according to a potential of its gate electrode. One of the first potential and the second potential generated by the first potential generation unit may be supplied to the gate electrode first transistor of each of the current sources in each of the plurality of unit circuit according to the correction data, and the on-potential generated by the second potential generation unit may be supplied to the gate electrode of the second transistor in each of the plurality of unit circuits. With this configuration, since a current according to the on-potential not depending on the first potential or the second potential is generated by the current generation circuit, concentration of the gray-scale levels of the plurality of electro-optical elements can be adjusted by suitably adjusting the on-potential, regardless of the correction data. Moreover, the first potential generation unit and the second potential generation unit may be a single circuit (for example, a potential generation circuit 25 of FIG. 1) or separate circuits.

In the electro-optical device according to the aspect of the invention, each of the plurality of unit circuits may include a correction data holding unit (for example, one of memory elements Ma1 to Ma3 of FIG. 2 or one of memory elements Mb1 to Mb3 of FIG. 12) that holds the correction data of the unit circuit, and the reference setting unit may generate the reference signal according to the correction data held by the correction data holding unit. With this configuration, since the correction data holding unit of each of the of the unit circuits holds the correction data, the correction data does not need to be supplied to the individual unit circuits each time the driving current is supplied to the electro-optical elements. Moreover, as the correction data holding unit, various memory elements, such as SRAM (Static RAM) or DRAM (Dynamic RAM), may be used. When the SRAM is used as the correction data holding unit, for example, if the correction data is supplied to all the unit circuits immediately after the application of power, the update of the correction data is not required in principle thereafter. Meanwhile, when the DRAM is used as the correction data holding unit, the correction data holding unit may be simplified (for example, one capacitive element can be used as the correction data holding unit), compared with a case where the SRAM is used.

In a case where the current control unit includes the driving transistor connected in parallel to the electro-optical element, the electro-optical element may be interposed between a feed line to which a high-level power potential (for example, a second potential V2 of FIG. 2) is supplied and a feed line to which a low-level power potential (for example, a ground potential Gnd of FIG. 2) is supplied. In this case, the electro-optical device according to the aspect of the invention may further include a switching element (for example, a transistor TA of FIG. 2) that controls electrical connection between a data line, to which a data signal according to the gray-scale data is supplied, and the gate electrode of the driving transistor, a selection unit (for example, a selection circuit 21 of FIG. 1) that generates a selection signal for turning on or off the switching element. The maximum potential of the data signal may be lower than the high-level power potential, and the minimum potential of the data signal may be higher than the low-level power potential. With this configuration, occurrence of noise due to the data signal can be prevented, compared with a case where the data signal varies within a range from the high-level power potential to the low-level power potential. Further, as the amplitude of the data signal is reduced, the size of the switching element can be reduced, and thus the amplitude of the selection signal can be reduced. As a result, occurrence of noise due to the change of the selection signal can be prevented.

The electro-optical device according to the aspect of the invention is used for various electronic apparatuses. Examples of the electronic apparatus include an apparatus that uses the electro-optical device as a display device. As such an electronic apparatus, a personal computer or a cellular phone may be exemplified. Of course, the use of the electro-optical device according to the aspect of the invention is not limited to image display. For example, the electro-optical device according to the aspect of the invention can be applied to an exposure device (exposure head) that forms a latent image on an image carrier, such as photoreceptor drum or the like, through irradiation of light beams.

Another aspect of the invention can be specified as a method of driving the above-described electro-optical device. The driving method includes causing the correction data holding unit of each of the unit circuits to hold the correction data of the unit circuit, and outputting the gray-scale data to the current control unit of each of the unit circuits after the correction data is held by the correction data holding unit, so as to drive each of the electro-optical elements. With this configuration, the gray-scale level of each of the electro-optical elements at the beginning of driving can be accurately corrected.

### BRIEF DESCRIPTION OF THE DRAWINGS

The invention will be described with reference to the accompanying drawings, wherein like numbers reference like elements.

FIG. 1 is a block diagram showing the configuration of an electro-optical device according to a first embodiment of the invention.

FIG. 2 is a circuit diagram showing the configuration of one unit circuit.

FIG. 3 is a block diagram showing the configuration of a potential generation circuit.

FIG. 4 is a timing chart illustrating the operation of an electro-optical device.

FIG. 5 is a circuit diagram showing the configuration of a unit circuit according to a second embodiment of the invention.

FIG. 6 is a block diagram showing the configuration of an electro-optical device according to a third embodiment of the invention.

FIG. 7 is a circuit diagram showing the configuration of one unit circuit.

FIG. 8 is a graph illustrating a change in driving current.

FIG. 9 is a circuit diagram showing the configuration of a unit circuit according to a modification.

FIG. 10 is a circuit diagram showing the configuration of a unit circuit according to a modification.

FIG. 11 is a circuit diagram showing the configuration of a unit circuit according to a modification.

FIG. 12 is a circuit diagram showing the configuration of a unit circuit according to a modification.

FIG. 13 is a circuit diagram showing the configuration of a potential generation circuit according to a modification.

FIG. 14 is a perspective view showing a specific example of an electronic apparatus according to the invention.

FIG. 15 is a perspective view showing a specific example of an electronic apparatus according to the invention.

FIG. 16 is a perspective view showing a specific example of an electronic apparatus according to the invention.

### DESCRIPTION OF EXEMPLARY EMBODIMENTS

### First Embodiment

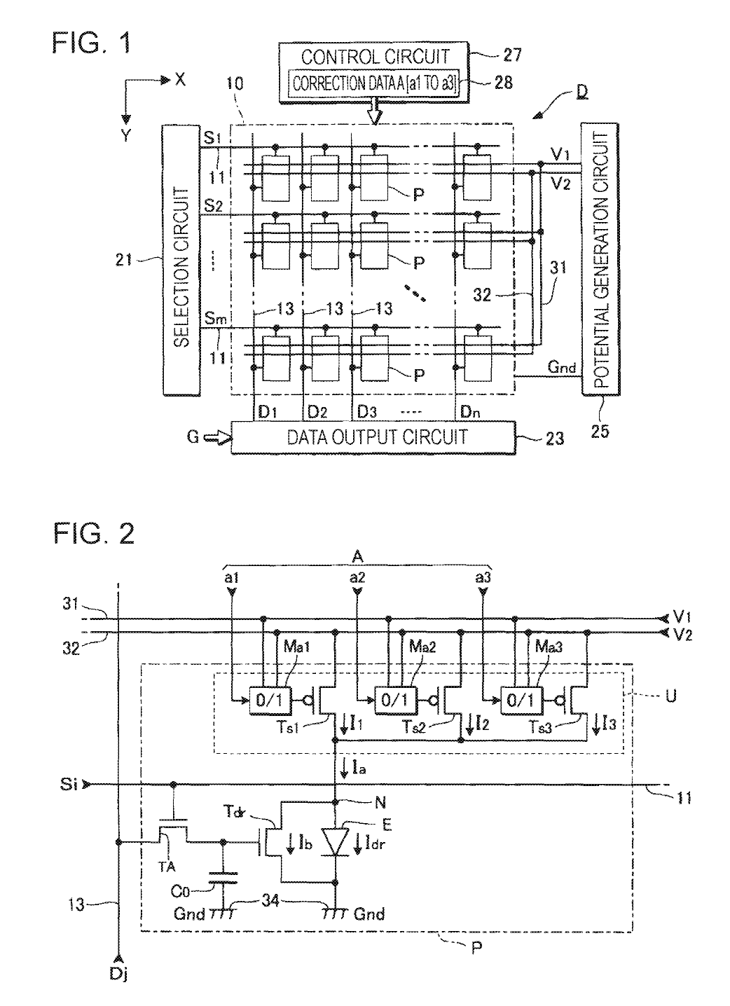

FIG. 1 is a block diagram showing the configuration of an electro-optical device according to a first embodiment of the invention. As shown in FIG. 1, the electro-optical device D includes an element array portion 10. In the element array portion 10, m selection lines 11 extending in an X direction, and n data lines 13 extending in a Y direction perpendicular to the X direction are formed. At intersections of the selection lines 11 and the data lines 13, unit circuits (pixel circuits) P are correspondingly disposed. Therefore, the unit circuits P are arranged in a matrix of m horizontal rows×n vertical columns in the X and Y directions.

In the vicinity of the element array portion 10, a selection circuit 21, a data output circuit 23, a potential generation circuit 25, and a control circuit 27 are disposed. Moreover, the position or shape of each circuit is arbitrarily set. For example, these circuits may be provided on a substrate together with the element array portion 10 or may be provided on a wiring board mounted on the substrate. Further, these circuits may be mounted in forms of IC chips or may be formed by transistors (thin film transistors) incorporated into the substrate together with the unit circuits P.

The control circuit 27 is a circuit that controls the selection circuit 21 and the data output circuit 23 by supplying various control signals, such as a clock signal and the like. The selection circuit 21 respectively outputs selection signals S1 to Sm to the m selection lines 11 so as to assign selection/non-selection of the individual selection lines 11. The data output circuit 23 respectively outputs data signals D1 to Dn to the n data lines 13 so as to assign gray-scale levels of the electro-optical elements E (see FIG. 2) in the individual unit circuits P.

The potential generation circuit 25 is a unit that generates a first potential V1, a second potential V2, and a ground potential Gnd. The ground potential Gnd is a potential that serves as a voltage reference for each part. The second potential V2 is a high-level power potential. The first potential V1 is a potential lower than the second potential V2. The first potential V1 is commonly supplied to the individual unit circuits P through a feed line 31, and the second potential V2 is commonly supplied to the individual unit circuits P through a feed line 32. Moreover, the specified operations of the selection circuit 21 and the data output circuit 23 and the specified configuration of the potential generation circuit 25 will be described below.

Next, the specified configuration of each of the unit circuits P will be described with reference to FIG. 2. Moreover, in FIG. 2, only one unit circuit P of the i-th row (where i is an integer satisfying the condition 1≦i≦m) and the j-th column (where j is an integer satisfying the condition 1≦j≦n) is shown, but all the unit circuits P in the element array portion 10 have the same configuration.

As shown in FIG. 2, one unit circuit P includes a reference setting circuit U, an electro-optical element E, a driving transistor Tdr, a capacitive element C0, and a transistor TA. The reference setting circuit U is a unit that generates a current (hereinafter, referred to as ‘reference current’) Ia serving as a reference of a gray-scale level of the electro-optical element E. Moreover, the detailed configuration of the reference setting circuit U will be described below.

The electro-optical element E is a light-emitting element (OLED element) in which a light-emitting layer formed of an organic EL (ElectroLuminescent) material is interposed between an anode and a cathode. The anode of the electro-optical element E is electrically connected to an output terminal of the reference setting circuit U at a node N. In each of the unit circuits P, the cathode of the electro-optical element E is commonly connected to a ground line 34 to which the ground potential Gnd is supplied. The electro-optical element E emits light with luminance according to a current (hereinafter, referred to as ‘driving current’) Idr flowing from the anode to the cathode through the light-emitting layer.

The driving transistor Tdr is an n-channel transistor that is connected in parallel to the electro-optical element E. That is, the driving transistor Tdr has a drain electrode connected to the node N (the anode of the electro-optical element E) and a source electrode connected to the ground line 34. Paying attention to a first path that is formed from the reference setting circuit U to the ground line 34 through the electro-optical element E, and a second path that branches off the first path at the node N and reaches the ground line 34, it can be understood that the driving transistor Tdr is disposed on the second path. A current Ib that flows from the node N to the ground line 34 through the drain electrode and the source electrode of the driving transistor Tdr changes according to a potential (hereinafter, referred to as ‘gate potential’) Vg that is supplied to the gate electrode of the driving transistor Tdr. Since the reference current Ia is the sum of the driving current Idr and the current Ib, the driving current Idr to be supplied to the electro-optical element E changes according to the current Ib flowing in the driving transistor Tdr (Idr=Ia−Ib). Accordingly, the electro-optical element E is controlled to a gray-scale level according to the gate potential Vg of the driving transistor Tdr. With this configuration, since the reference current Ia is kept substantially constant regardless of the gray-scale level of the electro-optical element E, when the driving current Idr is supplied to the electro-optical element E, the second potential V2 of the feed line 32 does not change. Therefore, a variation in gray-scale level of the electro-optical element E due to the change of the second potential V2 can be suppressed.

The capacitive element C0 is interposed between the gate electrode of the driving transistor Tdr and the ground line 34, and serves as a unit for holding the gate potential Vg. The transistor TA is a switching element that is disposed between the data line 13 and the gate electrode of the driving transistor Tdr so as to control electrical connection between them. A gate electrode of the transistor TA is connected to the selection line 11. Accordingly, when the selection signal Si to be supplied to the selection line 11 is changed to a high level, and the transistor TA is turned on, the data line 13 and the gate electrode of the driving transistor Tdr are electrically connected to each other. At this time, the gate potential Vg is set to a potential of the data signal Dj. Then, even though the selection signal Si is changed to a low level and the transistor TA is turned off, the gate potential Vg is held by the capacitive element C0.

A variation in gray-scale level of the electro-optical element E in each unit circuit P may occur. For example, when there is an error in characteristics (for example, light-emission efficiency) of the electro-optical element E, even though the driving current Idr having the same current value is supplied to all the electro-optical elements E, a variation in actual gray-scale level of the electro-optical elements E occurs. Further, when there is an error in a characteristic (for example, a threshold voltage) of the driving transistor Tdr, even though the same potential is supplied to the gate electrodes of the driving transistors Tdr in all the unit circuits P, a variation in current value of the driving currents Idr to be supplied to the electro-optical elements E (or the gray-scale levels of the electro-optical elements E) occurs. In addition, since a voltage drop occurs in the feed line 31 or the feed line 32, the first potential V1 or the second potential V2 that is supplied to the individual unit circuits P varies according to the positions of the unit circuits P in the element array portion 10 (specifically, a distance from the output terminal of the potential generation circuit 25). Since a current value of the reference current Ia serving as the reference of the driving current Idr is determined according to the first potential V1 or the second potential V2 (the details will be described below), a variation in current value of the driving currents Idr in the unit circuits P (or the gray-scale levels of the electro-optical elements E) occurs according to the positions of the unit circuits P.

In order to suppress the variation in gray-scale level described above, in this embodiment, the reference current Ia that is generated by the reference setting circuit U of each of the unit circuits P is set to the current value according to the correction data A of the unit circuit P. The correction data A corresponding to one unit circuit P is three-bit digital data having the most significant bit a1, a second bit a2, and the least significant bit a3. The correction data A is generated in advance for each electro-optical element E on the basis of the previous measurement result of the gray-scale level of the electro-optical element E. For example, the actual gray-scale levels of all the electro-optical elements E are measured with the assignment of the same gray-scale level for the individual electro-optical elements E. Then, the correction data A of each of the unit circuits P is determined on the basis of the measurement result (a variation in gray-scale level when the correction is not performed) such that the gray-scale levels of all the electro-optical elements E are made uniform (that is, an influence of a difference in a characteristic of the individual electro-optical elements E or a voltage drop in the feed line 31 or the feed line 32 is compensated). The correction data A of each of the unit circuits P set in such a manner is stored in a memory 28 provided in the control circuit 27, as shown in FIG. 1. The memory 28 is a unit (for example, EEPROM (Electrically Erasable Programmable Read-Only Memory) that stores the correction data A in a nonvolatile manner.

The reference setting circuit U of each of the unit circuits P is a unit (for example, a current-driven DAC) that generates reference current Ia having a current value according to the correction data A of the unit circuit P. As shown in FIG. 2, the reference setting circuit U includes three memory elements Ma1 to Ma3 and three transistors (hereinafter, referred to as ‘current source transistors’) Ts1 to Ts3 that correspond to the number of bits of the correction data A. A gate electrode of the current source transistor Tsk (where k is an integer satisfying the condition 1≦k≦3) is connected to an output terminal of the memory element Mak.

Each of the memory elements Mak included in one unit circuit P is a one-bit SRAM that stores one bit ak of the correction data A of the unit circuit P. When power is applied to the electro-optical device D, the control circuit 27 reads out the correction data A of each of the unit circuits P from the memory 28, and outputs the correction data A to the corresponding unit circuit P. With this processing, if the correction data A is held in the memory elements Ma1 to Ma3 of the unit circuit P, the control circuit 27 controls the selection circuit 21 or the data output circuit 23 to start to output the selection signals S1 to Sm or the data signals D1 to Dn. That is, after the correction data A is held in the memory elements Ma1 to Ma3 of each of the unit circuits P, the individual electro-optical elements E start to be driven. With this configuration, from a time when the individual electro-optical elements E start to be driven, the variation in gray-scale level of the individual electro-optical elements E can be efficiently suppressed.

As shown in FIG. 2, the memory elements Ma1 to Ma3 of each of the unit circuits P are commonly connected to the feed line 31, to which the first potential V1 is supplied, and the feed line 32, to which the second potential V2 is supplied. Each of the memory elements Mak outputs one of the first potential V1 and the second potential V2 according to the bit ak held therein. In detail, the memory element Mak outputs the first potential V1 if the bit ak is ‘1’, and outputs the second potential V2 if the bit ak is ‘0’.

The current source transistors Ts1 to Ts3 are p-channel transistors that respectively generate currents I1 to I3 according to the bits a1 to a3 of the correction data A. When the first potential V1 is supplied from the memory element Mak to the gate electrode (that is, when the bit ak is ‘1’), the current source transistor Tsk is turned on. At this time, the current Ik flows in the current source transistor Tsk. Meanwhile, when the second potential V2 is supplied from the memory element Mak to the gate electrode (that is, when the bit ak is ‘0’), since a gate-to-source voltage becomes zero, the current source transistor Tsk is turned off (the current Ik does not flow).

As described above, each of the three current source transistors Ts1 to Ts3 is selectively turned on according to the correction data A. Then, the currents Ik flowing in one or more turned-on current source transistors Tsk are added so as to generate the reference current Ia. In this embodiment, the characteristics (in particular, gain coefficients) of the three current source transistors Ts1 to Ts3 are selected such that a relative ratio of the current values of the currents I1 to I3 flowing when the first potential V1 is supplied to the gate electrode becomes ‘I1:I2:I3=4:2:1’. Accordingly, the reference current Ia is set to one of seven current values according to the correction data A. That is, the current source transistors Ts1 to Ts3 function as current sources for generating a plurality of currents I1 to I3 to be superposed by separate weighted values.

Like this embodiment, in a case where each of the current source transistors Ts1 to Ts3 is controlled in a two-value manner, an influence of an error in a characteristic of the current source transistors Ts1 to Ts3 (in particular, a variation in threshold voltage) on the reference current Ia can be reduced by changing the potential of the gate electrode of the current source transistor Tsk step by step, compared with a case where the current value of the reference current Ia is controlled.

Moreover, in this embodiment, a case where, when the bit ak is ‘0’, the second potential V2 is supplied to both the gate electrode and the source electrode of the current source transistor Tsk has been described. However, a potential different from the potential of the source electrode may be supplied to the gate electrode. Of course, in terms that the influence of the variation in a characteristic of the individual current source transistors Tsk is eliminated, thereby enabling reliable control of the states thereof, a potential to be supplied to the gate electrode of the current source transistor Tsk when the bit ak is ‘0’ is preferably a potential that reliably turns off the current source transistor Tsk (in general, like this embodiment, the same potential as that of the source electrode).

Here, a case where the characteristics of the individual current source transistors are different from one another has been described. However, when transistors having the same characteristics are arranged in parallel in a number according to the weighted values, each of the currents I1 to I3 can be set to a current value according to a desired weighted value. For example, when two transistors having the same characteristic as the current source transistor Ts3, instead of the current source transistor Ts2 of FIG. 2, are arranged in parallel, or when four transistors having the same characteristic as the current source transistor Ts3 are arranged in parallel, instead of the current source transistor Ts1, the relative ratio of the currents I1 to I3 can be set to ‘I1:I2:I3=4:2:1’.

Next, the peripheral circuits of the element array portion 10 will be described. The potential generation circuit 25 is a unit that generates the first potential V1 and the second potential V2. In this embodiment, the first potential V1 is set to a level at which the current source transistors Ts1 to Ts3 operate in a saturation region. Accordingly, the current Ik flowing in the current source transistor Tsk changes according to the level of the first potential V1 (the gate-to-source voltage).

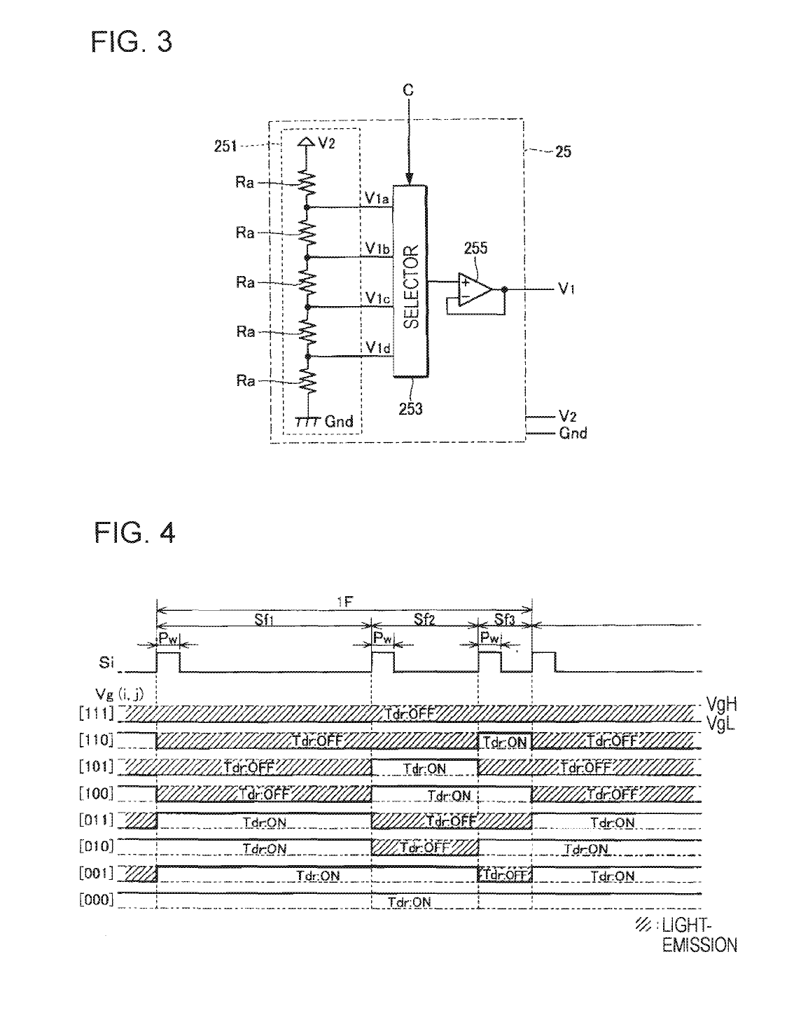

The potential generation circuit 25 in this embodiment variably generates the first potential V1. FIG. 3 is a block diagram showing the configuration of a part for generating the first potential V1 in the potential generation circuit 25. As shown in FIG. 3, the potential generation circuit 25 includes a resistive voltage dividing circuit 251, a selector 253, and a buffer 255. The resistive voltage dividing circuit 251 includes a plurality of resistive elements Ra that are connected in series between the second potential (high-level power potential) V2 and the ground potential Gnd. Four potentials V1a, V1b, V1c, and V1d generated through voltage division by the individual resistive elements Ra are supplied to the selector 253. The selector 253 is a unit that selects one of these potentials according to an adjusting signal C. The adjusting signal C is output from the control circuit 27 according to an operation of a switch (not shown), such as a knob or a button. The potential selected by the selector 253 is output from the buffer 255 to the feed line 31 through the first potential V1.

As described above, the level of the first potential V1 is adjusted according to the adjusting signal C. Since the current Ik (or the reference current Ia or the driving current Idr) flowing in the current source transistor Tsk is determined by the first potential V1, in this embodiment, concentration of the gray-scale levels of all the electro-optical elements E is collectively adjusted by the operation of the switch. Moreover, although a case where the first potential V1 is set according to the operation of the switch has been illustrated in the above description, an element serving as the reference of the first potential V1 is arbitrarily set. For example, the first potential V1 may be set according to the amount of external light, such as sunlight or illumination light.

The selection circuit 21 of FIG. 1 sequentially selects the selection lines 11 of the first row to the m-th row in that order. Specifically, the selection circuit 21 changes the selection signal Si to be supplied to one selection line 11 to the high level so as to select the corresponding selection line 11, and simultaneously keeps the selection signals to be supplied to other selection lines 11 (nonselected selection lines 11) at the low level. As shown in FIG. 4, in this embodiment, the selection signal Si becomes the high level in a write period Pw in each of three subframe periods Sf (Sf1 to Sf3) obtained by dividing a time length corresponding to one frame period (1F), and becomes the low level in other periods (an interval of the write period Pw in tandem). That is, each selection line 11 is selected in each frame period three times. The write period Pw is a period having a predetermined time length including a start point of each subframe period Sf1.

In this embodiment, the individual subframe periods Sf (Sf1 to Sf3) are selected such that a ratio of time lengths thereof is the power of two (that is, Sf1:Sf2:Sf3=4:2:1). For each subframe period Sf, light emission and extinction of each electro-optical element E are controlled, and thus the gray-scale level of the electro-optical element E is controlled to one of eight values (gray-scale level control by a pulse width modulation method).

The data output circuit 23 is a unit that outputs the gray-scale data Gj of the electro-optical element E in each unit circuit P to the data line 13, to which the unit circuit P is connected, as the data signal Dj. The gray-scale data G1 to Gn are supplied from various higher-level devices (or the control circuit 27), such as a CPU of an electronic apparatus, on which the electro-optical device D is mounted, or the like, to the data output circuit 23. The gray-scale data Gj of one electro-optical element E has the most significant bit g1, the second bit g2, and the least significant bit g3. The data signal Dj has one of a potential VgH and a potential VgL according to each bit of the gray-scale data Gj in the write period Pw of each subframe period Sf. Specifically, the data signal Dj has a level according to the bit g1 of the gray-scale data Gj in the write period Pw of the subframe period Sf1. That is, if the bit g1 is ‘0’, the data signal Dj becomes the potential VgH, and, if the bit g1 is ‘1’, the data signal Dj becomes the potential VgL. Similarly, the data signal Dj has a level according to the bit g2 in the write period Pw of the subframe period Sf2, and has a level according to the bit g3 in the write period Pw of the subframe period Sf3.

In each write period Pw where the selection signal Si becomes the high level, since the transistor TA is turned on, the potential VgH or VgL of the data signal Dj in the write period Pw is supplied to the gate electrode of the driving transistor Tdr through the transistor TA, and simultaneously is held in the capacitive element C0 until a new data signal Dj is supplied in the next write period Pw. That is, the capacitive element C0 functions as a unit that holds the gray-scale data Gj introduced to the unit circuit P in each write period Pw until the next write period Pw.

With the above operation, as shown in FIG. 4, the gate potential Vg of the driving transistor Tdr is controlled to one of the potential VgH and the potential VgL according to each of the bits g1 to g3 of the gray-scale data Gj in each subframe period Sf. That is, the gate potential Vg remains at the potential VgH over a time length according to the gray-scale data Gj in one frame period (1F), and becomes the potential VgL in the remaining period. Accordingly, the driving current Idr to be supplied to the electro-optical element E has a current value for causing the electro-optical element E to emit light in a period according to the gray-scale data Gj (a hatched period in FIG. 4) in one frame period, and has a current value for turning off the electro-optical element E in the remaining period.

In this embodiment, the amplitude (a difference between the potential VgH and the potential VgL) of each of the data signals D1 to Dn is smaller than a potential difference between the second potential V2 and the ground potential Gnd. Specifically, the potential VgH is lower than the second potential V2 (power potential), and the potential VgL is higher than the ground potential Gnd. From a different viewpoint, the resistance value (on resistance) of the driving transistor Tdr that is turned on by supply of the potential VgH increases, compared with a case where the driving transistor Tdr is turned on by supply the second potential V2 (power potential) to the gate electrode. As such, in a case where the amplitude of each of the data signals D1 to Dn is reduced, noise of each part due to a change in potential of the data signals D1 to Dn can be reduced, compared with a case where each of the data signals D1 to Dn varies within a range from the ground potential Gnd to the second potential V2. In addition, if the amplitude of each of the data signals D1 to Dn is reduced, the size of the transistor TA, through which the signal passes, can be reduced. Accordingly, since the amplitude of each of the selection signals S1 to Sm is reduced, according to this embodiment, noise of each part due to a change in potential of the selection signals S1 to Sm can be reduced.

As described above, in this embodiment, since the reference setting circuit U that generates the reference current Ia according to the correction data A is provided in each unit circuit P, a circuit that corrects the gray-scale data G1 to Gn on the basis of the correction data A is not required in principle. Therefore, the sizes of circuits to be disposed in the vicinity of the element array portion 10 can be reduced.

In this embodiment, the current source transistors Ts1 to Ts3 function as a constant current source, and the correction data A is generated such that an influence of the voltage drop in the feed line 31 or the feed line 32 is compensated. Accordingly, a variation of the first potential V1 or the second potential V2 according to the position of each unit circuit P is effectively compensated, and thus the current value of the reference current Ia can be adjusted to a desired value with high precision. From a different viewpoint, as described above, since the variation of the first potential V1 or the second potential V2 is compensated in the unit circuit P, a necessity for suppressing the voltage drop in the feed line 31 or the feed line 32 is reduced. Therefore, according to this embodiment, for example, the configuration for making the feed line 31 or the feed line 32 have low resistance (for example, an auxiliary wiring line formed of a conductive material having low resistance) is not required. Moreover, the voltage drop in the feed line 31 or the feed line 32 markedly appears as the element array portion 10 has a wider area. Therefore, the electro-optical device according to this embodiment that reduces the influence of the voltage drop is particularly suitable for a case where the electro-optical device D is used as a large-screen display device.

### Second Embodiment

Next, a second embodiment of the invention will be described. Moreover, the same parts as those in the first embodiment among parts constituting the following examples are represented by the same reference numerals, and the descriptions thereof will be omitted.

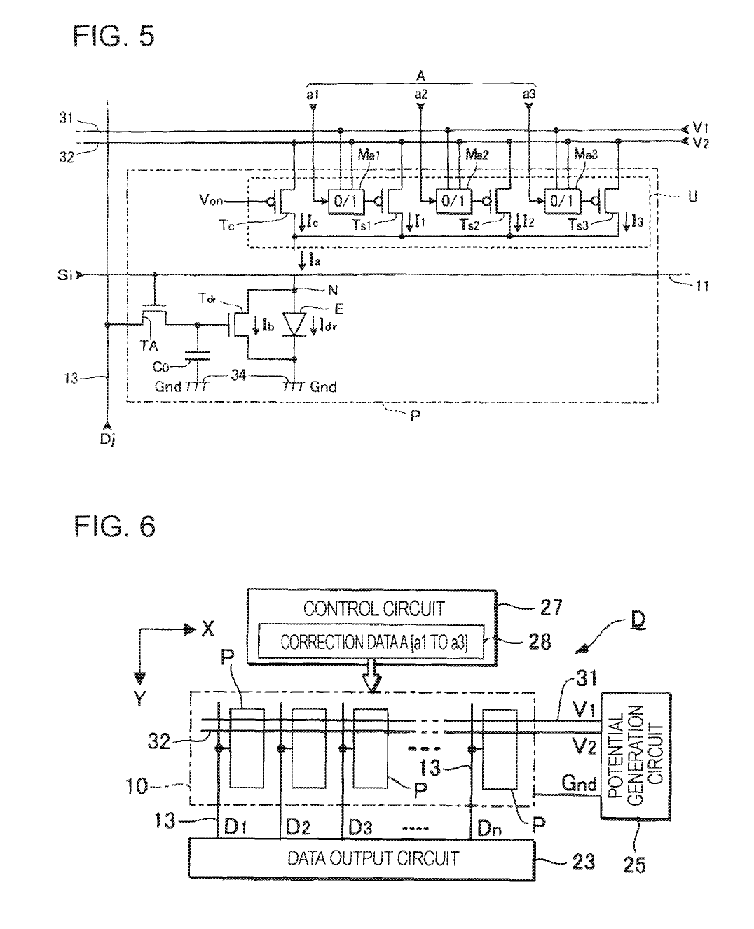

In the first embodiment, a case where the reference current Ia is generated by the three current source transistors Ts1 to Ts3 to be controlled according to the correction data A has been described. As shown in FIG. 5, the reference setting circuit U of this embodiment includes a p-channel transistor Tc in addition to the current source transistors Ts1 to Ts3 first embodiment. The transistor Tc is a unit that generates the current Ic according to the potential Von to be supplied to its gate electrode. Further, the source electrode of the transistor Tc is connected to the feed line 32 and the drain electrode thereof is connected to the node N. Accordingly, in this embodiment, the currents I1 to I3 respectively flowing in the current source transistor Ts1 to Ts3 are added to the current Ic flowing between the source and the drain of the transistor Tc, thereby generating the reference current Ia.

The potential Von to be supplied to the gate electrode of the transistor Tc is generated by the potential generation circuit 25 together with the first potential V1 or the second potential V2 and is commonly supplied to the individual unit circuits P. The potential Von is a potential (a potential lower than the second potential V2) that operates the transistor Tc in the saturation region, and is changed according to an instruction from the outside, like the first potential V1. Accordingly, the reference current Ia (or total brightness of the element array portion 10) in each of the unit circuits P can also be collectively changed by the change in the potential Von, in addition to the change of the first potential V1 according to the adjusting signal C. However, in this embodiment, the potential Von does not depend on the first potential V1 or the change thereof, and is set according to an input different from the adjusting signal C regardless of the first potential V1. With this configuration, the reference current Ia of each of the unit circuits P can be set minute and diversely, compared with a case where the potential Von is set in connection with the potential V1.

As described above, in this embodiment, the reference current Ia is generated by adding the current Ic not depending on the correction data A and the currents I1 to I3 according to the correction data A. With this configuration, since the current Ic common to the unit circuits P is generated by the transistor Tc, what is necessary is that a minute current corresponding to a difference between the current Ic and the desired reference current Idr is generated by the current source transistors Ts1 to Ts3. Accordingly, while the number of bits of the correction data A is reduced, the current value of the reference current Ia can be changed at minute steps according to the correction data A. Moreover, for each of the current source transistors Ts1 to Ts3, it is necessary to control the characteristic with high precision such that linearity of the correction data A and the currents I1 to I3 is secured. However, for the transistor Tc, unlike the current source transistors Ts1 to Ts3, precision for the characteristic is not required. Therefore, for the transistor Tc, the channel length can be reduced, compared with the current source transistors Ts1 to Ts3.

### Third Embodiment

In the above embodiments, a case (that is, the electro-optical device D suitable for image display) where a plurality of unit circuits P are arranged in the matrix shape has been described. In contrast, in an electro-optical device D of this embodiment, a plurality of unit circuits P are arranged in a linear shape. Such an electro-optical device D is suitably used as an exposure head that exposes a photosensitive member (for example, a photoreceptor drum) in an image forming apparatus, such as a printing apparatus or the like.

FIG. 6 is a block diagram showing the configuration of an electro-optical device D according to this embodiment. As shown in FIG. 6, in the element array portion 10, n unit circuits P are arranged along the X direction (main scanning direction). In the electro-optical device D, individual electro-optical elements E of an element array portion 10 are arranged to face the photosensitive member. The configuration of the data output circuit 23, the control circuit 27, or the potential generation circuit 25 is the same as that in each of the above embodiments. Moreover, like this embodiment, in a case where the unit circuits P are arranged in a linear shape, it is unnecessary to select the individual rows, and thus the selection lines 11 or the selection circuit 21 described in each of the above embodiments is not provided.

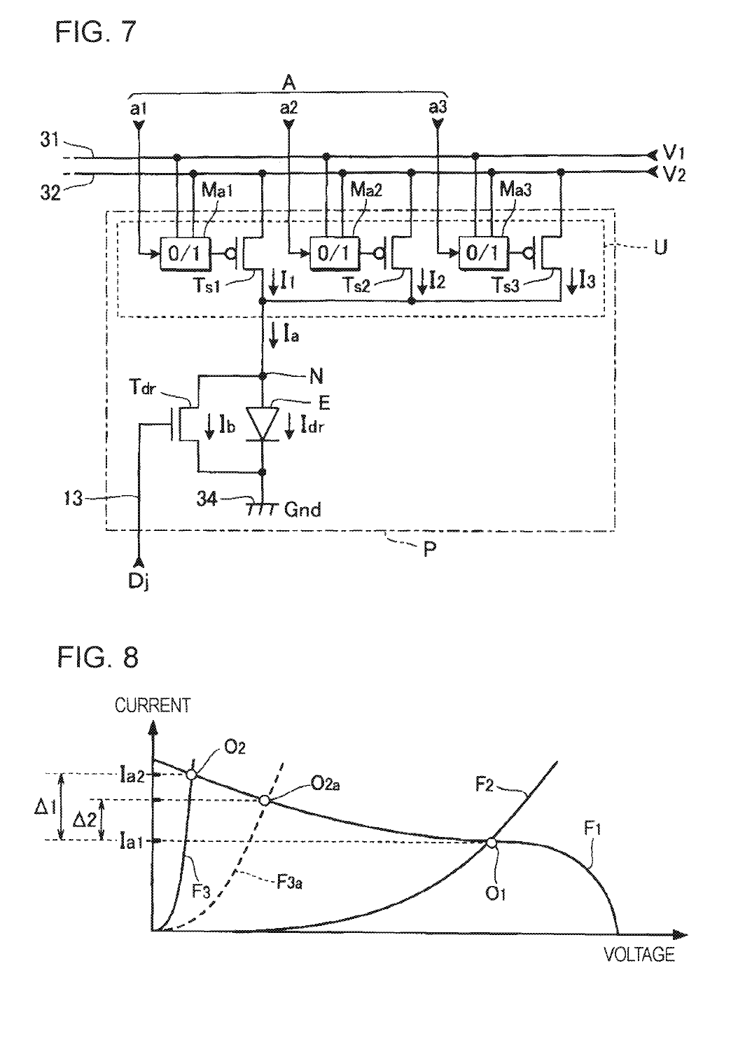

FIG. 7 is a block diagram showing the configuration of the unit circuit P according to this embodiment. As shown in FIG. 7, the gate electrode of the driving transistor Tdr is connected to the data line 13. The data signal Dj to be supplied to the data line 13 becomes the potential VgH over the time length according to the gray-scale data Gj in a predetermined period, and becomes the potential VgL in the remaining period. With this operation, the gray-scale levels (luminance) of the individual electro-optical elements E are controlled, and a latent image (electrostatic latent image) according to a desired image is formed on the surface of the photosensitive member exposed by the individual electro-optical elements E. Then, a toner (apparent image) attached to the latent image is fixed onto a recording material, such as a paper or the like. With this configuration, the same effects as those in the first embodiment can be obtained. Moreover, the transistor Tc (FIG. 5) described in the second embodiment may be added to the configuration of FIG. 7.

### Modifications

Various modifications can be added to each of the above embodiments. Specific modifications are illustrated as follows. Moreover, these modifications can be suitably combined.

### First Modification

FIG. 8 is a graph illustrating the relationship between the current flowing in each part and the potential of the node N in the above embodiments. In FIG. 8, a characteristic F1 represents the relationship between the potential of the node N (horizontal axis) and the reference current Ia (vertical axis). Further, a characteristic F2 represents the relationship between the potential of the node N and the driving current Idr, and a characteristic F3 represents the relationship between the potential of the node N and the current Ib flowing in the driving transistor Tdr. In FIG. 8, and intersection ο1 of the characteristic F1 and the characteristic F2 corresponds to an operation point when the electro-optical element E emits light, and an intersection ο2 of the characteristic F1 and the characteristic F3 corresponds to an operation point when the electro-optical element E is turned off. As shown in FIG. 8, according to the characteristics of the individual parts of the unit circuit P, the reference current Ia may change (a change amount Δ1) when the electro-optical element E emits light (the operation point ο1) and when the electro-optical element E is turned off (the operation point ο2).

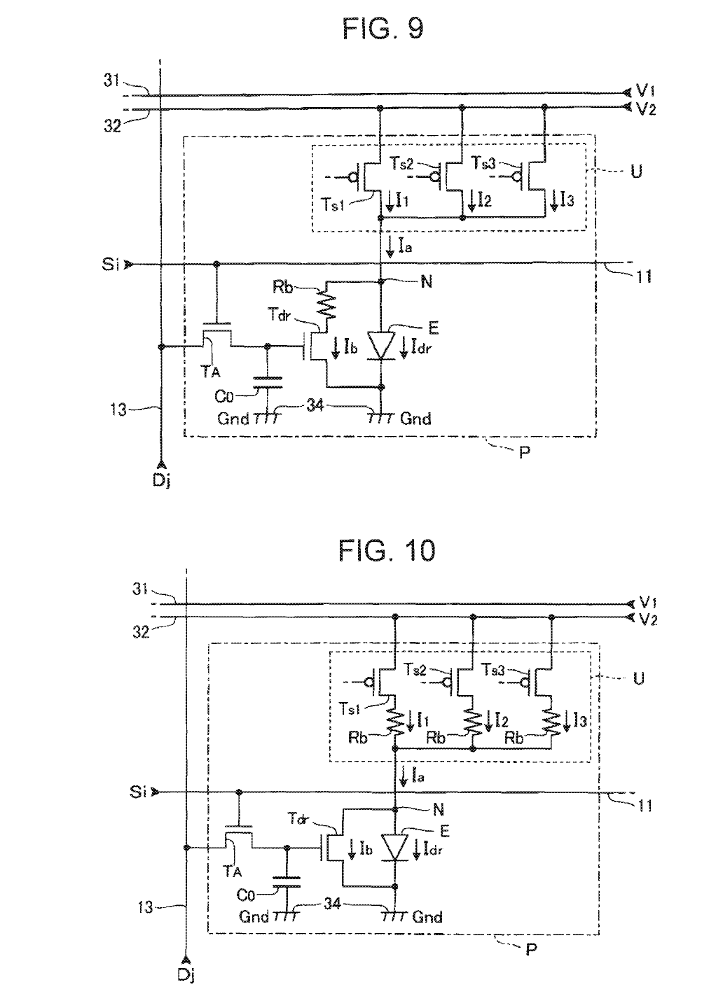

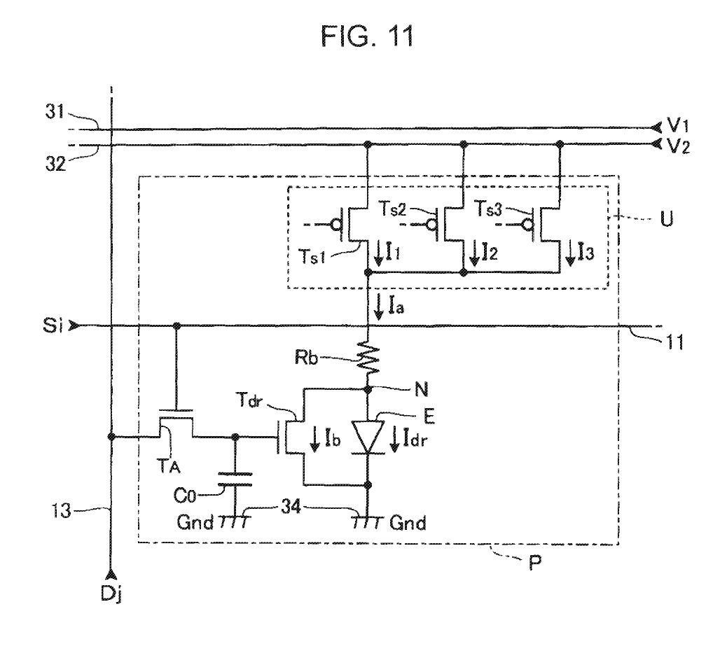

In order to suppress the change of the reference current Ia, as shown in FIGS. 9 to 11, a resistive element Rb may be disposed on a path through the reference setting circuit U and the driving transistor Tdr (in particular, between the reference setting circuit U and the driving transistor Tdr). In the configuration of FIG. 9, the resistive element Rb is interposed between the drain electrode of the driving transistor Tdr and the node N. In the configuration of FIG. 10, the resistive element Rb is interposed between the drain electrode of each of the current source transistors Ts1 to Ts3 and the node N. Further, in the configuration of FIG. 11, the resistive element Rb is interposed between the reference setting circuit U and the node N.

According to the configuration of FIGS. 9 to 11, it is possible to approximate the resistance value of the first path that is formed from the reference setting circuit U to the ground line 34 through the electro-optical element E, and the resistance value of the second path that is formed from the reference setting circuit U to the ground line 34 through the driving transistor Tdr, compared with a case where the resistive element Rb is not provided. That is, the characteristic F3 of FIG. 8 is changed to a characteristic F3a by disposing the resistive element Rb, as shown in FIGS. 9 to 11. Accordingly, the operation point ο2 when the electro-optical element E is turned off is changed to the operation point ο2 close to the operation point ο1 at the time of light emission. Therefore, as shown in FIG. 8, the change amount of the reference current Ia can be reduced from Δ1 to Δ2 at the time of light emission and extinction of the electro-optical element E.

### Second Modification

The configuration of the unit circuit P is suitably changed. For example, a unit (the memory elements Ma1 to Ma3 or the memory elements Mb1 to Mb3) that holds the correction data A may not be provided in each unit circuit P. In this configuration, a potential according to the correction data A is continuously supplied to the gate electrode of each of the current source transistors Ts1 to Ts3 of the unit circuits P from the peripheral circuits.

In the above embodiments, a case where the reference current Ia is generated by the reference setting circuit U has been described. However, the reference setting circuit U may generate a voltage (hereinafter, referred to as ‘reference voltage’) as a reference of the driving current Idr according to the correction data A (for example, a voltage output-type DAC is used as the reference setting circuit U). In this configuration, the driving transistor is interposed between the reference setting circuit U and the electro-optical element E. In this case, the potential according to the gray-scale data Gj is supplied to the gate electrode of the driving transistor. Accordingly, driving current Idr that is supplied from the reference setting circuit U to the electro-optical element E through the driving transistor is controlled to a current value according to the reference voltage (correction data A) and the gray-scale data Gj. As such, in the above embodiments, the configuration in which the driving current Idr is controlled according to the level of the reference signal to be generated by the reference setting circuit U (the current value of the reference current Ia or the current value of the reference voltage) and the gray-scale data G is suitably used.

### Third Modification

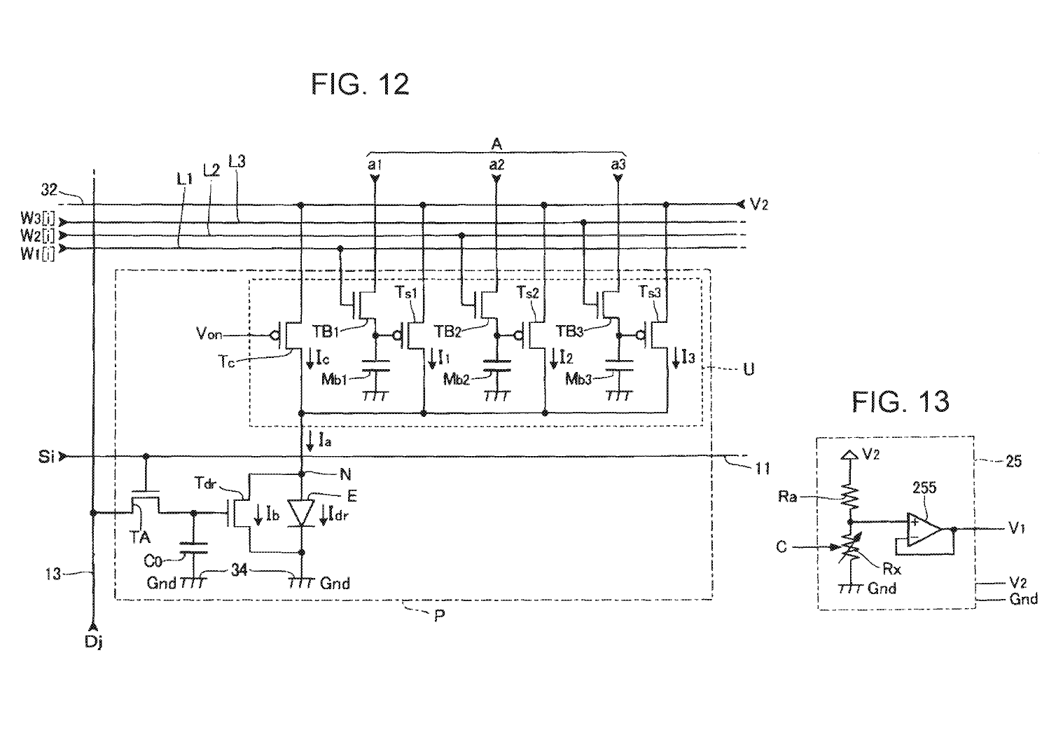

In the above embodiments, a case where the memory elements Ma1 to Ma3 for storing the correction data A are the SRAMs has been described. However, as shown in FIG. 12, the correction data A may be stored in a DRAM. The unit circuit P of FIG. 12 includes sets of a memory element Mbk (Mb1 to Mb3) and a transistor TBk (TB1 to TB3) (that is, one-bit DRAM), instead of the memory element Mak of the second embodiment. The memory element Mbk is a capacitive element that holds a voltage according to a bit ak of the correction data A, and is interposed between the gate electrode of the current source transistor Tsk and the ground line. Therefore, like the above embodiments, the potential according to the bit ak is supplied to the gate electrode of the current source transistor Tsk.

Each of the transistors TB1 to TB3 is a switching element that controls electrical connection of the memory elements Mb1 to Mb3 and the control circuit 27 (memory 28). The gate of the transistor TBk is connected to a signal line Lk to which a refresh signal Wk[i] is supplied. Therefore, the transistor TBk is controlled to be turned on or off according to the level of the refresh signal Wk[i].

When the refresh signal Wk[i] is changed to the high level and the transistor TBk is turned on, the bit ak output from the control circuit 27 is introduced to the unit circuit P through the transistor TBk. Accordingly, the potential according to the bit ak is supplied to the gate electrode of the current source transistor Tsk, and is held in the memory element Mbk. Therefore, in the configuration of FIG. 12, the reference current Ia having the current value according to the correction data A is generated. In the above configuration, since the DRAM is used to hold the correction data A, the size of the unit circuit P or a manufacturing cost can be reduced, compared with a case where the SRAM is disposed in each of the unit circuits P.

By the way, the voltage held by the memory element Mbk is gradually decreasing due to leakage of electrical charges. Accordingly, a refresh operation of the content stored in the memory element Mbk (an operation of supplying the bit ak from the control circuit 27 to the memory element Mbk when the transistor TBk is controlled to be turned on by the refresh signal Wk[i]) is preferably performed several times at any time (for example, regularly) even though the individual electro-optical elements E are driven. According to this configuration, the current value of the reference current Ia can be kept to a desired value for a long time.

### Fourth Modification

Of course, the number of bits of the correction data A or the gray-scale data G is not limited the above illustration. Accordingly, the number of parts constituting one unit circuit P (the current source transistor Tsk or the memory element Mak, the memory element Mbk, or the transistor TBk), or the number of subframe periods included in one frame period is suitably changed from the above illustration.

### Fifth Modification

Although a case where the gray-scale level of the electro-optical element E is controlled by setting the driving current Idr to a pulse width according to the gray-scale data Gj has been described in the above embodiments, a method of controlling the gray-scale level of the electro-optical element E is arbitrarily set. For example, the gray-scale level of the electro-optical element E can be controlled by changing the current value of the driving current Idr step by step according to the gray-scale data Gj.

### Sixth Modification

Although a case where the first potential V1 is variably generated in the above embodiments, the second potential V2 may be variably generated. In addition, the configuration for changing the first potential V1 is arbitrarily set. For example, instead of the potential generation circuit 25 of FIG. 3, as shown in FIG. 13, a potential generation circuit 25 that generates the first potential V1 through division by the resistive element Ra and the variable resistive element Rx may be used. With this configuration, the desired first potential V1 is generated by changing the resistance value of the variable resistive element Rx according to the adjusting signal C.

### Seventh Modification

Although a case where the OLED element is used as the electro-optical element E has been described in the above embodiments, the invention can be applied to various electro-optical devices that use other electro-optical elements. For example, like the above embodiments, the invention can be applied to a display device that uses an inorganic EL element, a field emission display (FED), a surface-conduction electron-emitter display (SED), a ballistic electron surface emitting display (BSD), and a display device that uses a light-emitting diode.

### APPLICATIONS

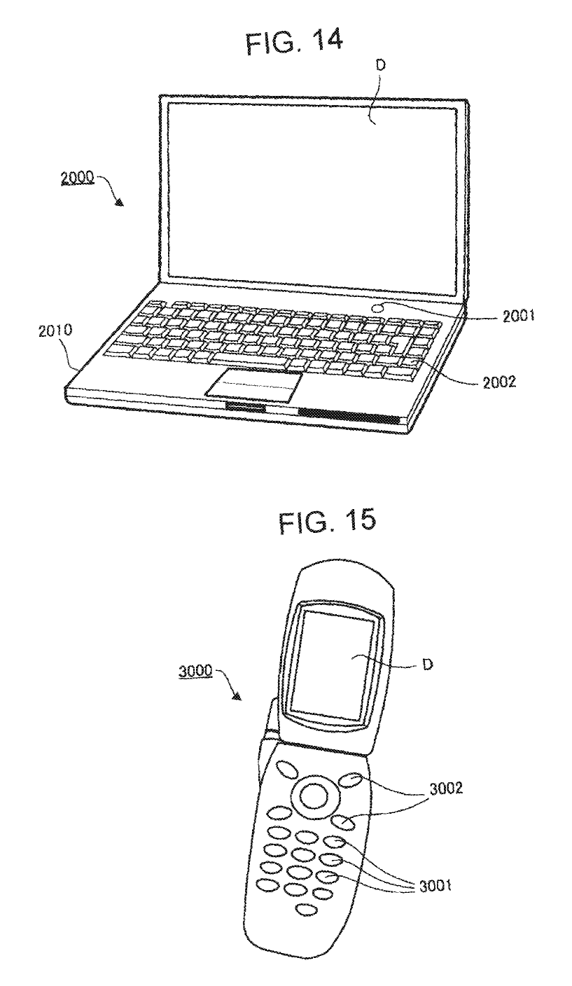

Next, an electronic apparatus that uses the electro-optical device according to each of the embodiments of the invention will be described. FIG. 14 is a perspective view showing the configuration of a mobile personal computer that uses the electro-optical device D according to each of the above embodiments as a display device. A personal computer 2000 includes the electro-optical device D as a display device and a main body 2010. In the main body 2010, a power switch 2001 and a keyboard 2002 are provided. In this electro-optical device D, since an OLED element is used as the electro-optical element E, a screen can be displayed at a wide viewing angle with ease to view.

FIG. 15 shows the configuration of a cellular phone to which the electro-optical device D according to each of the above embodiments is applied. A cellular phone 3000 includes a plurality of operating buttons 3001, scroll buttons 3002, and the electro-optical device D as a display device. If the scroll buttons 3002 operate, a screen that is displayed in the element array portion 10 of the electro-optical device D is scrolled.

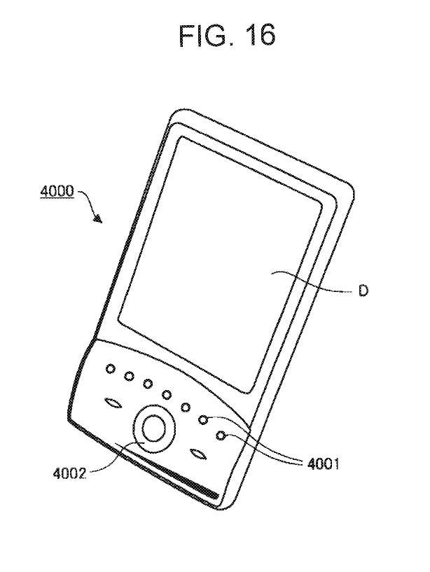

FIG. 16 shows the configuration of a personal digital assistant (PDA) to which the electro-optical device D according to each of the above embodiments is applied. A personal digital assistant 4000 includes a plurality of operating buttons 4001 and a power switch 4002, and the electro-optical device D as a display device. If the power switch 4002 operates, various kinds of information, such as a directory, a scheduler, and the like, are displayed in the element array portion 10 of the electro-optical device D.

Moreover, examples of the electronic apparatus to which the electro-optical device according to the embodiments of the invention is applied include a digital still camera, a television, a video camera, a car navigation device, a pager, an electronic organizer, an electronic paper, an electronic calculator, a word processor, a work station, a video phone, a POS terminal, a printer, a scanner, a copy machine, a video player, an apparatus having a touch panel, and the like, in addition to the apparatuses shown in FIGS. 14 to 16.

What is claimed is:

1. An electro-optical device, comprising:
a plurality of unit circuits that each include:
an electro-optical element that has a gray-scale level according a current value of a driving current,
a reference setting unit that generates a reference signal having a level according to correction data of the respective unit circuit, and
a current control unit that controls the driving current to be supplied to the electro-optical element to a current value according to gray-scale data assigning a gray-scale level of the unit circuit and the level of the reference signal generated by the reference setting unit.

2. The electro-optical device according to claim 1,
the reference setting unit generating a reference current having a current value according to the correction data as a reference signal.

3. The electro-optical device according to claim 2,
the current control unit including a driving transistor disposed on a second path branching off a first path from the reference setting unit to the electro-optical element so as to control a current of the second path according to the gray-scale data.

4. The electro-optical device according to claim 3, further comprising:
a resistive element disposed on a path of a current passing through the reference setting unit and the driving transistor.

5. The electro-optical device according to claim 2,
the reference setting unit of each of the unit circuits including a plurality of current sources that respectively generate a current according to the correction data of the unit circuit, and generates the reference current by adding the currents generated by the individual current sources.

6. The electro-optical device according to claim 5, further comprising:
a potential generation unit that generates a first potential and a second potential different from each other,
each of the current sources including a first transistor that generates a current according to a potential of its gate electrode, and
one of the first potential and the second potential generated by the potential generation unit being supplied to the gate electrode of the first transistor according to the correction data.

7. The electro-optical device according to claim 6,
the first potential being a potential that operates the first transistor in a saturation region, and the second potential being a potential that turns off the first transistor.

8. The electro-optical device according to claim 6,
the potential generation unit variably generating the first potential.

9. The electro-optical device according to claim 5,
each of the unit circuits including a current generation circuit that generates a current having a current value not depending on the correction data, and
the reference setting unit generating the reference current by adding the currents generated by the individual current sources and the current generated by the current generation circuit.

10. The electro-optical device according to claim 9, further comprising:
a first potential generation unit that generates a first potential and a second potential that are different from each other; and
a second potential generation unit that generates an on-potential not depending on the first potential and the second potential,
each of the plurality of current sources including a first transistor that generates a current according to a potential of its gate electrode,
the current generation circuit including a second transistor that generates a current according to a potential of its gate electrode,
one of the first potential and the second potential generated by the first potential generation unit being supplied to the gate electrode first transistor of each of the current sources in each of the plurality of unit circuit according to the correction data, and
the on-potential generated by the second potential generation unit being supplied to the gate electrode of the second transistor in each of the plurality of unit circuits.

11. The electro-optical device according to claim 1,
each of the plurality of unit circuits including a correction data holding unit that holds the correction data of the unit circuit, and
the reference setting unit generating the reference signal according to the correction data held by the correction data holding unit.

12. An electronic apparatus, comprising:
the electro-optical device according to claim 1.

13. A method of driving an electro-optical device, that includes a plurality of unit circuits, each of the plurality of unit circuits including an electro-optical element that has a gray-scale level according to a current value of a driving current, a correction data holding unit that holds correction data, a reference setting unit that generates a reference signal having a level according to the correction data held by the correction data holding unit, and a current control unit that controls the driving current to be supplied to the electro-optical element to a current value according to gray-scale data and the level of the reference signal generated by the reference setting unit, the method comprising:
causing the correction data holding unit of each of the unit circuits to hold the correction data of the respective unit circuit; and
outputting the gray-scale data to the current control unit of each of the unit circuits after the correction data is held by the correction data holding unit, so as to drive each of the electro-optical elements.

14. An electro-optical device, comprising:
a plurality of unit circuits that each include circuitry that adjusts a level of current allowed to pass through an electro-optical element of the unit circuit to perform at least one kind of correction to the intensity of light output by the electro-optical element; and
a peripheral circuit that adjusts a level of current allowed to pass through the electro-optical elements of the respective unit circuits to perform another kind of correction to the intensity of light output by the respective electro-optical elements that is different from the correction performed by each of the respective unit circuits.

15. The electro-optical device according to claim 14,
wherein each of the plurality of unit circuits includes a correction data holding unit that holds correction data of the unit circuit, and
wherein the unit circuit adjusts a level of current allowed to pass through an electro-optical element based upon the correction data held by the correction data holding unit.

16. The electro-optical device according to claim 15,
wherein each respective unit circuit adjusts a level of current allowed to pass through the electro-optical element of the unit circuit to correct a gray-scale level output by the electro-optical element.
